(19) United States
(12) Patent Application Publication
(10) Pub. No.: US 2022/0264221 A1
(43) Pub. Date: Aug. 18, 2022

(54) ELECTRONIC APPARATUS THAT ADJUSTS SENSITIVITY OF MICROPHONE ACCORDING TO MOTION OF ONE HAND AND OTHER HAND IN PREDETERMINED GESTURE, AND IMAGE FORMING APPARATUS

(71) Applicant: KYOCERA Document Solutions Inc., Osaka (JP)

(72) Inventor: Kin O, Osaka (JP)

(73) Assignee: KYOCERA Document Solutions Inc., Osaka (JP)

(21) Appl. No.: 17/588,903

(22) Filed: Jan. 31, 2022

(30) Foreign Application Priority Data
Feb. 17, 2021 (JP) 2021-023564

(51) Int. Cl. H04R 3/00; G06F 3/01; G06V 40/20; G10L 15/22; H04R 1/32; G06F 3/14; H04R 1/08; H04R 1/02

(52) U.S. Cl. CPC H04R 3/00; G06F 3/017; G06V 40/28; H04R 1/028; H04R 1/326; G06F 3/14; H04R 1/08; G10L 15/22

(57) ABSTRACT

An electronic apparatus includes a microphone, a camera, and a control device. The control device acts as a voice recognizer, a controller, a gesture recognizer, and a sensitivity adjuster. The voice recognizer recognizes voice of the user inputted to the microphone. The controller controls an operation of the electronic apparatus, according to a result of voice recognition by the voice recognizer. The gesture recognizer recognizes, on a basis of an image shot by the camera, a predetermined gesture in which one hand of the user is positioned beside an end of the user's mouth, and the other hand is positioned beside the other end of the user's mouth. The sensitivity adjuster adjusts sensitivity of the microphone, according to a motion of the hands, when the gesture recognizer recognizes respective motions of the one hand and the other hand in the predetermined gesture.

### INCORPORATION BY REFERENCE

This application claims priority to Japanese Patent Application No. 2021-023564 filed on 17 Feb. 2021, the entire contents of which are incorporated by reference herein.

### BACKGROUND

The present disclosure relates to an electronic apparatus that can be operated by voice, and to an image forming apparatus.

Electronic apparatuses configured to be operated by voice commands (hereinafter, “voice operation”) are known. To accurately execute the voice operation, it is necessary to accurately recognize the voice of the user. For such purpose, a technique has been developed including recognizing the voice, for example when the speaker's conversation voice is interrupted by ambient noise, on the basis of a silent mouthing image of the speaker, using a preregistered silent mouthing pattern, thereby making up voice information corresponding to the missing portion in the recognized voice. In addition, a technique to facilitate the volume of voice outputted from an external device to be controlled, is known.

### SUMMARY

The disclosure proposes further improvement of the foregoing technique.

In an aspect, the disclosure provides an electronic apparatus including a microphone, a camera, and a control device. The camera shoots a user of the electronic apparatus. The control device includes a processor, and acts as a voice recognizer, a controller, a gesture recognizer, and a sensitivity adjuster, when the processor operates according to a control program. The voice recognizer recognizes voice of the user inputted to the microphone. The controller controls an operation of the electronic apparatus, according to a result of voice recognition by the voice recognizer. The gesture recognizer recognizes, on a basis of an image shot by the camera, a predetermined gesture in which one hand of the user is positioned beside an end of the user's mouth, and the other hand is positioned beside the other end of the user's mouth. The sensitivity adjuster adjusts sensitivity of the microphone, according to a motion of the hands, when the gesture recognizer recognizes respective motions of the one hand and the other hand in the predetermined gesture.

In another aspect, the disclosure provides an image forming apparatus including the foregoing electronic apparatus, and an image forming device that forms an image on a recording medium.

### BRIEF DESCRIPTION OF THE DRAWINGS

FIG. 1 is a perspective view showing the appearance of an image forming apparatus according to a first embodiment of the disclosure;

FIG. 2 is a functional block diagram showing an essential internal configuration of the image forming apparatus according to the first embodiment;

FIG. 3 is a schematic drawing showing an example of a predetermined gesture;

FIG. 4A is a schematic drawing for explaining a central position of a mouth;

FIG. 4B is a schematic drawing for explaining an interval between the hands;

FIG. 5 is a flowchart showing an example of a voice operation receiving process;

FIG. 6 is a flowchart showing an example of a sensitivity adjustment process according to the first embodiment;

FIG. 7A is a schematic drawing showing an example of a state where the interval between the hands has been narrowed;

FIG. 7B is a schematic drawing showing an example of a state where the interval between the hands has been widened;

FIG. 8 is a functional block diagram showing an essential internal configuration of an image forming apparatus according to a second embodiment; and

FIG. 9 is a flowchart showing an example of a sensitivity adjustment process according to the second embodiment.

### DETAILED DESCRIPTION

### First Embodiment

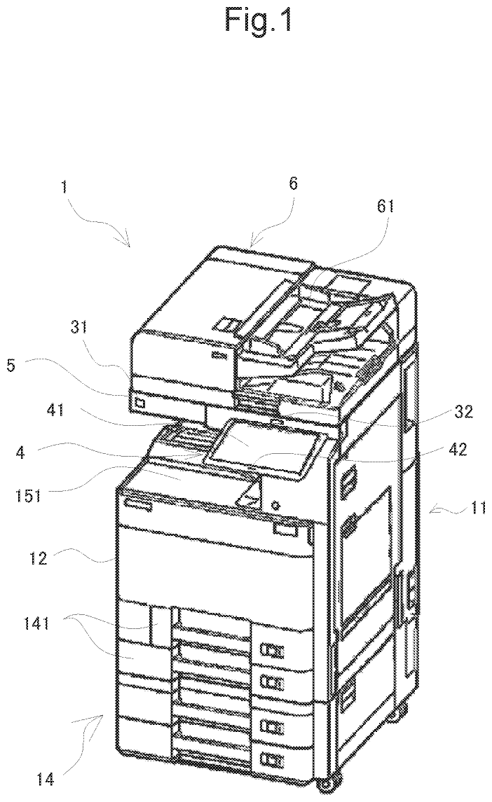

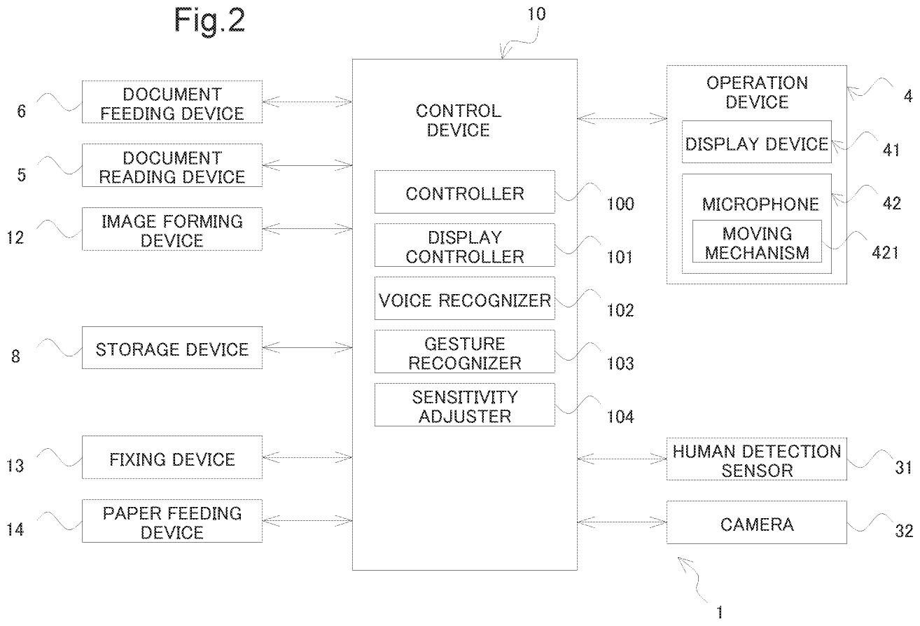

Hereafter, an electronic apparatus and an image forming apparatus according to some embodiments of the disclosure will be described, with reference to the drawings. FIG. 1 is a perspective view showing the appearance of the image forming apparatus according to a first embodiment of the disclosure. FIG. 2 is a functional block diagram showing an essential internal configuration of the image forming apparatus according to the first embodiment.

The image forming apparatus 1 is a multifunction peripheral having a plurality of functions, such as copying, printing, scanning, and facsimile transmission. The image forming apparatus 1 includes, inside a main body 11, a control device 10, a document feeding device 6, a document reading device 5, an image forming device 12, a storage device 8, a fixing device 13, a paper feeding device 14, an operation device 4, a human detection sensor 31, and a camera 32. The image forming apparatus 1 exemplifies the electronic apparatus according to the embodiment of the disclosure.

The document feeding device 6 is provided on the upper face of the document reading device 5, so as to be opened and closed via a hinge or the like. The document feeding device 6 serves as a document retention cover, when a source document placed on a platen glass is to be read. The document feeding device 6 is configured as an automatic document feeder (ADF) including a document tray 61. The document feeding device 6 delivers the source documents placed on the document tray 61, to the document reading device 5 one by one.

To perform the document reading operation, the image forming apparatus 1 operates as follows. The document reading device 5 optically reads the image on a source document, delivered thereto from the document feeding device 6 or placed on a platen glass 161, and generates image data. The image data generated by the document reading device 5 is stored, for example, in an image memory.

To perform the image forming operation, the image forming apparatus 1 operates as follows. The image recording device 12 forms a toner image on a recording sheet exemplifying the recording medium in the disclosure, delivered from the paper feeding device 14, on the basis of the image data generated through the document reading operation, the image data stored in the image memory, or image data received from a computer connected via a network.

The fixing device 13 heats and presses the recording sheet on which the toner image has been formed by the image forming device 12, to thereby fix the toner image onto the recording sheet. The recording sheet that has undergone the fixing process is delivered to an output tray 151. The paper feeding device 14 includes a plurality of paper cassettes 141.

The storage device 8 is a large-capacity memory unit such as a hard disk drive (HDD) or a solid state drive (SSD). The storage device 8 contains various types of control programs.

The operation device 4 includes hard keys and a tenkey. Through such keys, the operation device 4 receives instructions from the user to execute the functions and operations that the image forming apparatus 1 is configured to perform, for example the image forming operation. The operation device 4 includes a display device 41 for displaying, for example, an operation guide for the user, and a microphone 42. The display device 4 also receives the user's instruction inputted by a touch operation performed on the display device 41, and detected by a touch panel function provided for the display device 41.

The display device 41 includes, for example, a liquid crystal display (LCD). The display device 41 includes a touch panel. When the user touches a button or a key displayed on the screen of the display device 41, the touch panel receives the instruction corresponding to the touched position.

The microphone 42 acquires the ambient sound around the image forming apparatus 1, and converts the sound into an electrical signal. In particular, the microphone 42 acquires the voice of the user of the image forming apparatus 1. The microphone 42 is provided in the operation device 4, because such a position is appropriate to acquire the user's voice.

The microphone 42 is directional. The microphone 42 includes a movement mechanism 421. The movement mechanism 421 is driven by a motor, under the control of a controller 100 to be subsequently described, so as to mechanically adjust the direction of the microphone 42, thereby varying the direction of the sound collection axis (direction of highest sensitivity) of the microphone 42. Alternatively, a plurality of microphones 42 may be arranged in an array, and the controller 100 may vary the direction of the sound collection axis, by processing the voice signal outputted from the plurality of microphones 42.

The human detection sensor 31 detects the access of a person to the image forming apparatus 1. Examples of the human detection sensor 31 include a sensor that detects the infrared light emitted from the human body, and an ultrasonic sensor. The human detection sensor 31 outputs a signal indicating the detection result, to the control device 10.

The camera 32 shoots a predetermined range in front of the image forming apparatus 1, and outputs the shot image to the control device 10. The camera 32 is controlled by the controller 100, so as to start the image shooting when the human detection sensor 31 detects presence of a person, and finishes the image shooting when the human detection sensor 31 stops detecting the presence of the person.

The control device 10 includes a processor, a random-access memory (RAM), a read-only memory (ROM), and an exclusive hardware circuit. The processor is, for example, a central processing device (CPU), an application specific integrated circuit (ASIC), or a micro processing device (MPU).

The control device 10 acts, when the processor operates according to a control program stored in the storage device 8, as the controller 100, a display controller 101, a voice recognizer 102, a gesture recognizer 103, and a sensitivity adjuster 104. Here, the controller 100 and other components cited above may each be constituted in the form of a hardware circuit, instead of being realized by the control device 10 according to the control program. This also applies to other embodiments, unless otherwise specifically noted.

The controller 100 controls the overall operation of the image forming apparatus 1. The controller 100 is connected to the document feeding device 6, the document reading device 5, the image forming device 12, the storage device 8, the fixing device 13, the paper feeding device 14, the operation device 4, the human detection sensor 31, and the camera 32, to control the operation of the mentioned components. For example, the controller 100 controls the operation of the image forming device 12, so as to form the image of the source document, acquired through the reading operation by the document reading device 5, on the recording sheet exemplifying the recording medium in the disclosure.

The display controller 101 controls the displaying operation of the display device 41. For example, the display controller 101 causes the display device 41 to display an operation screen for the user to input an instruction.

The voice recognizer 102 is a module that recognizes the user's voice inputted to the microphone 42, using a known technique.

The gesture recognizer 103 recognizes the gesture of the user from the image shot by the camera 32, using a known technique. For example, the gesture recognizer 103 recognizes the gesture of the user from the image shot by the camera 32, on the basis of information for identifying the gesture, registered in advance in the storage device 8. The information for identifying the gesture includes predetermined images representing shapes of the hand (in this embodiment, respective images of the left and right hands, seen from the lateral side of the palm, not from the front side of the palm), and predetermined images representing the shapes of the mouth (in this embodiment, shape of the mouth in a face seen from the front side).

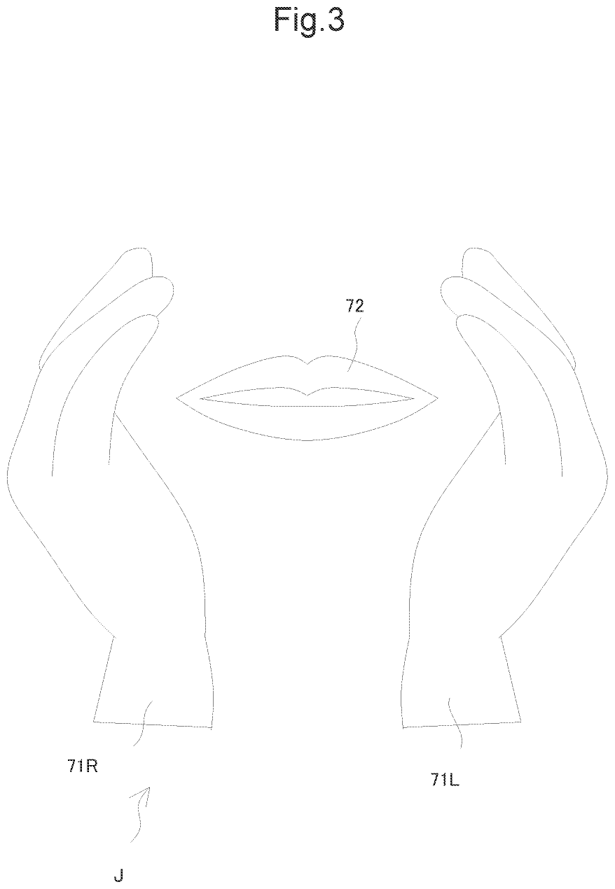

The gesture recognizer 103 performs image processing such as pattern matching, and binarization if need be, with respect to the image shot by the camera 32, to thereby detect the image of the hands and the mouth of the user (hereinafter, simply “hands and mouth”) from the shot image, on the basis of the registered information. The gesture recognizer 103 identifies the position of the hands and mouth detected as above, on the basis of the coordinate in the shot image. The gesture recognizer 103 further decides whether the predetermined gesture, in which one hand of the user is positioned beside an end of the user's mouth, and the other hand is positioned beside the other end of the user's mouth, has been performed. FIG. 3 illustrates an example of the predetermined gesture J. As shown therein, the predetermined gesture J represents the gesture in which the user applies the hands to the mouth as if applying a megaphone. In the gesture J, the right hand 71R and the left hand 71L, each assuming a curved shape, are located on the respective sides of the mouth 72.

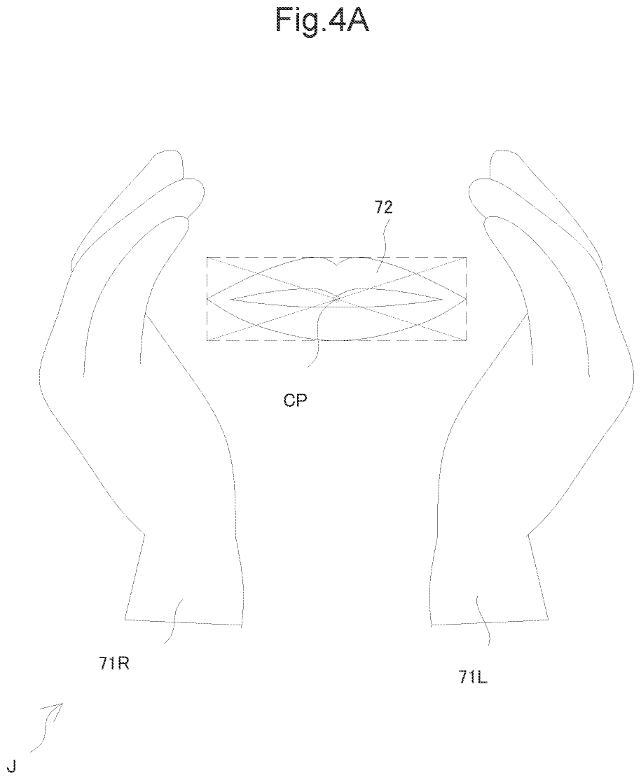

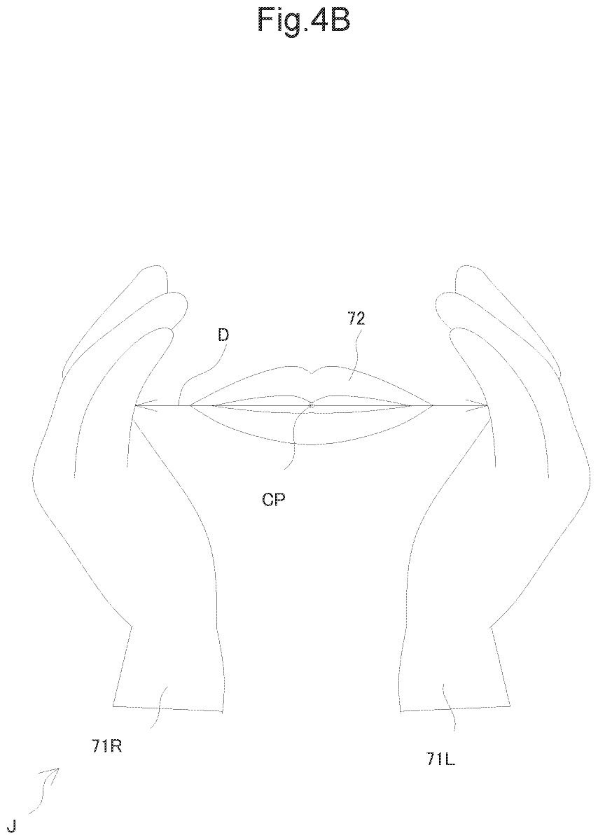

The gesture recognizer 103 also detects the central position of the user's mouth 72 (hereinafter, simply “mouth 72”), using the image shot by the camera 32. For example, the gesture recognizer 103 detects the image representing the mouth 72 from the image shot by the camera 32, identifies the central position of the mouth 72, and identifies the coordinate of the central position of the mouth 72 in a three-dimensional space coordinate. For example, the gesture recognizer 103 identifies, as the central position CP of the mouth 72, the center of a rectangle defined by, as shown in FIG. 4A, a vertical line passing the right corner of the mouth 72, a vertical line passing the left corner of the mouth 72, a horizontal line passing the upper end of the upper lip (lip peak), and a horizontal line passing the lower end of the lower lip, thus identifying the coordinate of the central position CP of the mouth 72.

Further, the gesture recognizer 103 calculates an interval between the user's hands (distance between the right hand 71R and the left hand 71L), using the image shot by the camera 32. For example, the gesture recognizer 103 calculates, as shown in FIG. 4B, the distance between the respective contact points of a horizontal line passing the central position CP of the mouth 72 with the right hand 71R and the left hand 71L, as the interval D between the hands.

The sensitivity adjuster 104 adjusts the sensitivity of the microphone 42, according to the motion of each of the user's hands in the predetermined gesture J, recognized by the gesture recognizer 103. For example, the sensitivity adjuster 104 controls the value of a variable resistor provided inside the microphone 42, to adjust the sensitivity of the microphone 42.

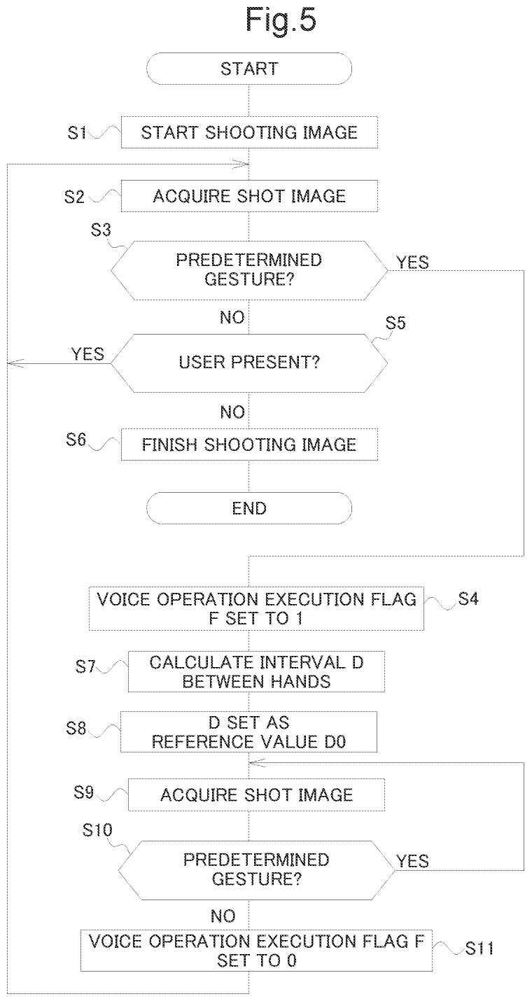

Hereunder, an example of a voice operation receiving process, performed by the image forming apparatus 1, will be described with reference to a flowchart shown in FIG. 5. The voice operation receiving process is started, when the human detection sensor 31 detects the presence of a person (i.e., when a person comes close to the image forming apparatus 1).

The controller 100 causes the camera 32 to start shooting the image (step S1). The gesture recognizer 103 acquires the image shot by the camera 32 (step S2), and decides whether the user's gesture accords with the predetermined gesture J, on the basis of the shot image that has been acquired (step S3).

When the gesture recognizer 103 decides that the user's gesture discords from the predetermined gesture J (NO at step S3), the controller 100 decides whether the person is still present around the image forming apparatus 1, according to the detection signal from the human detection sensor 31 (step S5).

Upon deciding that the user is no longer present (NO at step S5), the controller 100 causes the camera 32 to finish shooting the image (step S6). After step S6, the controller 100 finishes the voice operation receiving process. In contrast, upon deciding that the user is still present (YES at step S5), the controller 100 returns to step S2. When the human detection sensor 31 is continuously detecting the presence of a person, the controller 100 decides that the user is still present, and when the human detection sensor 31 stops detecting the presence of the user, the controller 100 decides that the user is no longer present.

When the gesture recognizer 103 decides that the user's gesture accords with the predetermined gesture J (YES at step S3), the controller 100 sets a voice operation execution flag F to “1”, to start receiving the voice operation by the user (step S4).

After step S4, the gesture recognizer 103 calculates the interval D (see FIG. 4B) between the hands of the user making the predetermined gesture J, using the image shot by the camera 32 (step S7), and the sensitivity adjuster 104 sets the interval D between the hands calculated by the gesture recognizer 103, as a reference value D0 (step S8).

After step S8, the gesture recognizer 103 further acquires the image shot by the camera 32 (step S9), and decides whether the user is still making the predetermined gesture J at this point, on the basis of the shot image acquired (step S10).

When the gesture recognizer 103 decides that the user is no longer making the predetermined gesture J (NO at step S10), the controller 100 sets the voice operation execution flag F to “0” (step S11), and finishes the receiving process of the voice operation by the user. After step S11, the controller 100 returns to step S2.

In contrast, when the gesture recognizer 103 decides that the user is still making the predetermined gesture J (YES at step S10), the controller 100 returns to step S9. In other words, the controller 100 continues with the receiving process of the voice operation by the user.

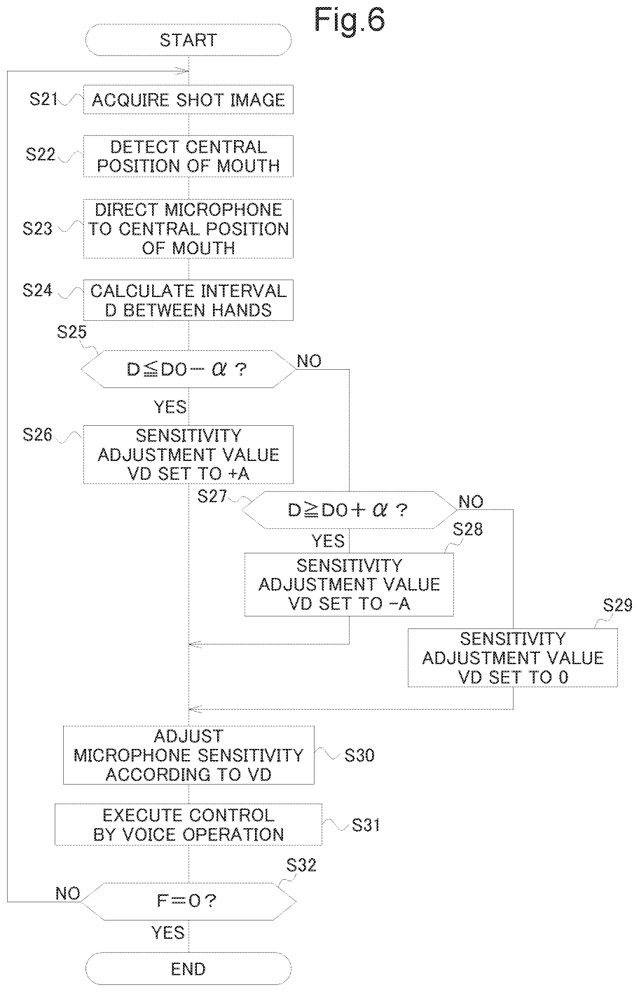

Hereunder, an example of a sensitivity adjustment process, performed by the image forming apparatus 1 according to the first embodiment, will be described with reference to a flowchart shown in FIG. 6. The sensitivity adjustment process is started when the voice operation execution flag F is set to “1” (step S4), in the voice operation receiving process shown in FIG. 5. The sensitivity adjustment process is performed parallel to step S10 and step S9, while step S10 and step S9 of the voice operation receiving process are being repeated.

In the sensitivity adjustment process, the gesture recognizer 103 acquires the image shot by the camera 32 (step S21), and detects the central position CP of the mouth 72 (see FIG. 4A), using the acquired image, shot by the camera 32 (step S22). The controller 100 controls the movement mechanism 421, such that the sound collection axis of the microphone 42 is directed to the central position CP detected by the gesture recognizer 103 (step S23).

The gesture recognizer 103 calculates the interval D (see FIG. 4B) between the hands of the user making the predetermined gesture J, using the image shot by the camera 32 (step S24). The sensitivity adjuster 104 decides whether the interval D calculated by the gesture recognizer 103 is equal to or smaller than a value obtained by subtracting a predetermined set value a from the reference value D0 set at step S8 (step S25). In other words, the sensitivity adjuster 104 decides whether the interval D between the hands at the time that step S24 has been performed is narrower than the interval D at the time that step S7 was performed.

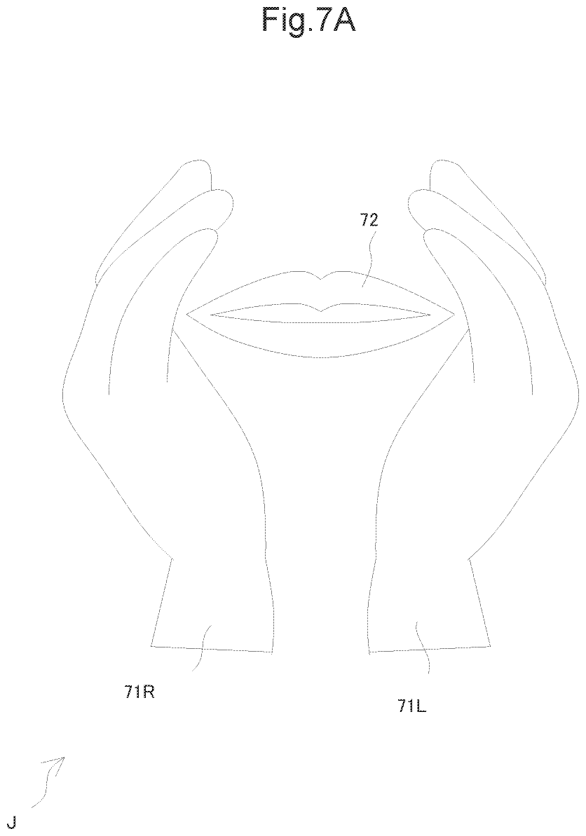

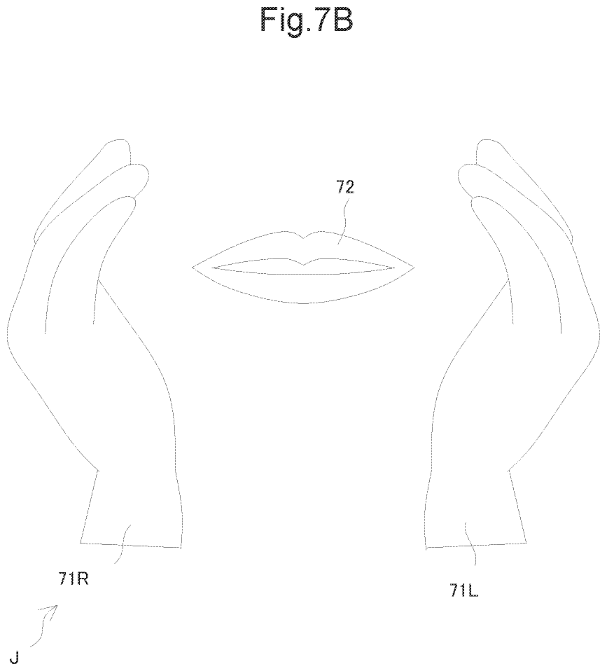

Upon deciding that the interval D between the hands at the time that step S24 has been performed (e.g., FIG. 7A) is narrower than the interval D at the time that step S7 was performed (e.g., FIG. 4B) (YES at step S25), the sensitivity adjuster 104 sets a sensitivity adjustment value VD to “+A (A is a positive number)” (step S26), to raise the sensitivity of the microphone 42. After step S26, the controller 100 proceeds to step S30. The motion of the user making the interval D between the hands narrower in the predetermined gesture J is approximate to the gesture that one makes when speaking in a low voice. Accordingly, causing the sensitivity adjuster 104 to raise the sensitivity of the microphone 42, when the user narrows the interval D between the hands, facilitates the user to intuitively perceive the operation for raising the sensitivity of the microphone 42.

In contrast, upon deciding that the interval D between the hands has not been narrowed (NO at step S25), the sensitivity adjuster 104 decides whether the interval D between the hands is equal to or larger than a value obtained by adding the set value a to the reference value D0 (step S27). In other words, the sensitivity adjuster 104 decides whether the interval D between the hands at the time that step S24 has been performed is wider than the interval D at the time that step S7 was performed.

Upon deciding that the interval D between the hands at the time that step S24 has been performed (e.g., FIG. 7B) is wider than the interval D at the time that step S7 was performed (e.g., FIG. 4B) (YES at step S27), the sensitivity adjuster 104 sets the sensitivity adjustment value VD to “−A” (step S28), to lower the sensitivity of the microphone 42. After step S28, the controller 100 proceeds to step S30. The motion of the user making the interval D between the hands wider in the predetermined gesture J is approximate to the gesture that one makes when speaking in a loud voice. Accordingly, causing the sensitivity adjuster 104 to lower the sensitivity of the microphone 42, when the user widens the interval D between the hands, facilitates the user to intuitively perceive the operation for lowering the sensitivity of the microphone 42.

Upon deciding that the interval D between the hands has not been widened (NO at step S27), the sensitivity adjuster 104 sets the sensitivity adjustment value VD to “0” (step S29), to maintain the sensitivity of the microphone 42 as it is, without adjustment. After step S29, the controller 100 proceeds to step S30. In this case, the interval D between the hands has neither been widened nor narrowed, or has been set to the initial state after once being widened or narrowed, and therefore the sensitivity adjuster 104 keeps the sensitivity of the microphone 42 as it is, without making any adjustment.

At step S30, the sensitivity adjuster 104 adjusts the sensitivity of the microphone 42, according to the sensitivity adjustment value VD. More specifically, when the sensitivity adjustment value VD is set to “+A”, the sensitivity of the microphone 42 is raised, and when the sensitivity adjustment value VD is set to “−A”, the sensitivity of the microphone 42 is lowered.

When the user's voice is inputted to the microphone 42, the controller 100 controls the operation of the image forming apparatus 1, according to the result of the voice recognition by the voice recognizer 102 (step S31). Thus, the voice operation by the user with respect to the image forming apparatus 1 can be performed.

After step S31, the controller 100 decides whether the voice operation execution flag F is “0” (step S32). Upon deciding that the voice operation execution flag F is “0” (YES at step S32), the controller 100 finishes the sensitivity adjustment process. On the other hand, upon deciding that the voice operation execution flag F is not set to “0” (NO at step S32), the controller 100 returns to step S21.

Now, it is necessary to accurately recognize the voice of the user, in order to accurately execute the voice operation. However, there may be a case where the volume of the user's voice is insufficient, despite the user speaking in a loud voice toward the electronic apparatus, and the voice operation is unable to be properly executed. If the circumstance permits the user to speak in a loud voice, such a case would be rare. Actually, however, it is often difficult for the user to output a loud voice, owing to the circumstances. For example, the image forming apparatus such as a copier or a multifunction peripheral is, in many of the cases, installed in an office or a commercial facility to be utilized in common by a plurality of persons, where it is not desirable to speak in a loud voice.

With the known technique to make up a missing portion in the voice information using the silent mouthing pattern, the silent mouthing pattern has to be registered in advance. Therefore, this technique is not applicable to the silent mouthing image of an unregistered pattern, and therefore the missing portion of the voice information is unable to be made up. In addition, the known technique to adjust the volume of the voice to be outputted is not intended to be applied to the voice operation.

With the configuration according to the first embodiment, unlike the above, the user can easily adjust the sensitivity of the microphone 42, simply by varying the motion of the hands, and therefore the accuracy of the voice operation can be easily improved. In addition, the gesture, approximate to the gesture that one makes when speaking in a low voice or loud voice, is adopted as the gesture required when varying the motion of the hands. Therefore, the user can intuitively perceive the operation required for the adjustment of the sensitivity of the microphone 42.

Further, since the sound collection axis of the microphone 42 is directed to the central position CP of the mouth 72, the accuracy of the voice operation can be further improved. In addition, the voice operation of the user is received only when the user is making the predetermined gesture, in other words the method of the voice operation is limited. Therefore, the image forming apparatus 1 can be prevented from being erroneously operated, for example by an ambient noise.

### Second Embodiment

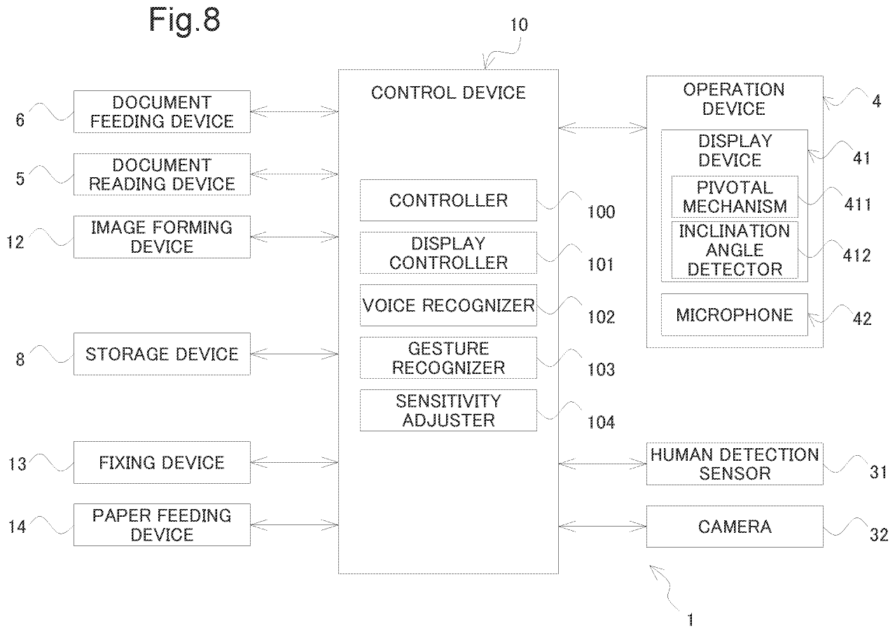

Hereunder, the image forming apparatus 1 according to a second embodiment will be described. FIG. 8 is a functional block diagram showing the essential internal configuration of the image forming apparatus according to the second embodiment. The image forming apparatus 1 according to the second embodiment is different from the image forming apparatus 1 according to the first embodiment shown in FIG. 1, in that the microphone 42 is without the movement mechanism 421, and that the display device 41 includes a pivotal mechanism 411 and an inclination angle detector 412. The description about the configuration and processings similar to those of the first embodiment will not be repeated.

The pivotal mechanism 411 is controlled by the controller 100, to make the display device 41 pivot about a pivotal axis extending in a horizontal direction with a motor, toward the front side of the image forming apparatus 1 (so as to face the user standing in front of the image forming apparatus 1), in other words so as to assume an upright posture. The display device 41, having the screen oriented to the front side as result of the pivotal movement, is made to pivot about the pivotal axis extending in the horizontal direction, such that the screen becomes inclined downward from an upwardly inclined posture, or vice versa. Here, the pivotal mechanism 411 may be configured to make the display device 41 pivot about the pivotal axis by manual operation of the user, instead of being driven by the motor. When the display device 41 is made to pivot, the inclination of the screen of the display device 41 varies.

The inclination angle detector 412 is a sensor that detects an inclination angle θ of the display device 41. The inclination angle detector 412 outputs a detection signal indicating the detected inclination angle, to the control device 10.

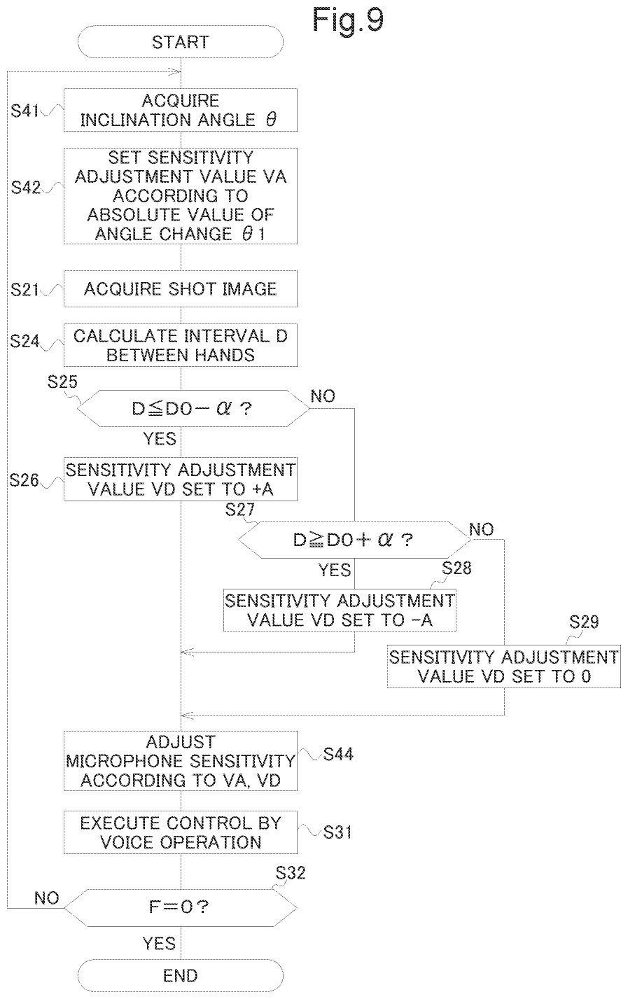

Hereunder, an example of the sensitivity adjustment process, performed by the image forming apparatus 1 according to the second embodiment, will be described with reference to a flowchart shown in FIG. 9. The sensitivity adjustment process is started when the voice operation execution flag F is set to “1” (step S4), in the voice operation receiving process shown in FIG. 5. The sensitivity adjustment process is performed parallel to step S10 and step S9, while step S10 and step S9 of the voice operation receiving process are being repeated.

The flowchart shown in FIG. 9 is different from the flowchart shown in FIG. 6, in not including step S22 and step S23, in including step S41 and step S42, and including step S44 instead of step S30. Only such differences from the flowchart of FIG. 6 will be described hereunder.

In the sensitivity adjustment process according to the second embodiment, the sensitivity adjuster 104 acquires the information indicating the inclination angle θ of the display device 41, detected by the inclination angle detector 412 (step S41). After step S41, the sensitivity adjuster 104 sets a sensitivity adjustment value VA for adjusting the sensitivity of the microphone 42, according to an absolute value of a change in angle θ1 from a predetermined initial angle θ0 (θ1=θ0−θ) (step S42).

For example, when the screen of the display device 41 is made to pivot upward, it can be presumed that the face of the user is located at a higher position than the face of another user who was viewing the screen of the display device 41 inclined at the initial angle θ0, before the pivotal motion. Accordingly, the user's face is located farther from the microphone 42 provided at a fixed position in the image forming apparatus 1, compared with the state before the pivotal motion. Likewise, when the screen of the display device 41 is made to pivot downward, it can be presumed that the face of the user is located at a lower position than the face of another user who was viewing the screen of the display device 41 inclined at the initial angle θ0, before the pivotal motion. Accordingly, the user's face is located farther from the microphone 42, compared with the state before the pivotal motion. For such reason, the sensitivity adjuster 104 increases the sensitivity adjustment value VA, as the absolute value of the change in angle θ1 becomes larger.

At step S44, the sensitivity adjuster 104 adjusts the sensitivity of the microphone 42 according to the sensitivity adjustment values VA and VD. For example, the sensitivity adjuster 104 adjusts the sensitivity of the microphone 42, according to the sum of the sensitivity adjustment value VA and the sensitivity adjustment value VD.

According to the second embodiment, the sensitivity of the microphone 42 is adjusted, not only according to the interval D between the hands of the user, but also according to the inclination of the display device 41, and therefore the sensitivity of the microphone 42 can be more properly adjusted. As result, the accuracy of the voice operation can be further improved.

### Third Embodiment

According to the first and second embodiments, the sensitivity of the microphone 42 is simply raised or lowered, by setting the sensitivity adjustment value VD to “+A” when the interval D between the hands of the user becomes narrower, and setting the sensitivity adjustment value VD to “−A” when the interval D between the hands of the user becomes wider. However, the disclosure is not limited to such an arrangement. In a third embodiment of the disclosure, the sensitivity adjuster 104 raises the sensitivity of the microphone 42 as the interval D between the hands becomes narrower, and lowers the sensitivity of the microphone 42 as the interval D between the hands becomes wider, on the basis of the recognition result provided by the gesture recognizer 103. In other words, the sensitivity adjuster 104 adjusts the sensitivity of the microphone 42, in increments or linearly. For example, the sensitivity adjuster 104 may set a value obtained from a mathematical expression “(reference value D0−interval D)×change rate R”, as the sensitivity adjustment value VD.

### Fourth Embodiment

In the image forming apparatus 1 according to a fourth embodiment of the disclosure, the display controller 101 is configured to switch the display of the display device 41, from a normal mode to a universal mode which provides higher visibility than the normal mode. The display in the universal mode is designed for persons unfamiliar with complicated operation of devices, such as physically challenged persons and aged persons.

When the display controller 101 switches the display of the display device 41 from the normal mode to the universal mode, the sensitivity adjuster 104 increases the change rate R of the sensitivity of the microphone 42, in the mathematical expression “sensitivity adjustment value VD=(reference value D0−interval D between the hands)×change rate R”, from the change rate R in the normal mode.

According to the fourth embodiment, the sensitivity of the microphone 42 can be largely varied, despite the motion of narrowing or widening the interval D between the hands being small, when the user is a physically challenged person or an aged person. As result, the user-friendliness of the apparatus can be further improved.

The disclosure may be modified in various manners, without limitation to the foregoing embodiments. Although the electronic apparatus according to the disclosure is exemplified by the image forming apparatus configured as a multifunction peripheral in the embodiments, the disclosure is also applicable to different types of electronic apparatuses.

The configurations and processings described with reference to FIG. 1 to FIG. 9 are merely exemplary, and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is:

1. An electronic apparatus comprising:
a microphone;
a camera that shoots a user of the electronic apparatus; and
a control device including a processor, and configured to act, when the processor operates according to a control program, as:
a voice recognizer that recognizes voice of the user inputted to the microphone;
a controller that controls an operation of the electronic apparatus, according to a result of voice recognition by the voice recognizer;
a gesture recognizer that recognizes, on a basis of an image shot by the camera, a predetermined gesture in which one hand of the user is positioned beside an end of the user's mouth, and the other hand is positioned beside the other end of the user's mouth; and
a sensitivity adjuster that adjusts sensitivity of the microphone, according to a motion of the hands, when the gesture recognizer recognizes respective motions of the one hand and the other hand in the predetermined gesture.

2. The electronic apparatus according to claim 1,
wherein the sensitivity adjuster raises the sensitivity of the microphone by a predetermined value, upon deciding that an interval between the one hand and the other hand in the predetermined gesture has been narrowed, and lowers the sensitivity of the microphone by the predetermined value, upon deciding that the interval has been widened, on a basis of a result of recognition by the gesture recognizer.

3. The electronic apparatus according to claim 1,
wherein the sensitivity adjuster raises the sensitivity of the microphone, as an interval between the one hand and the other hand in the predetermined gesture becomes narrower, and lowers the sensitivity of the microphone as the interval becomes wider, on a basis of a result of recognition by the gesture recognizer.

4. The electronic apparatus according to claim 1, further comprising a movement mechanism that moves the microphone,
wherein the microphone is directional,
the gesture recognizer detects a central position of the user's mouth using the image shot by the camera, and
the controller directs a sound collection axis of the microphone to the central position detected by the gesture recognizer, by controlling the movement mechanism.

5. The electronic apparatus according to claim 1, further comprising:
a display device that can be made to pivot about a pivotal axis extending in a horizontal direction; and
an inclination angle detector that detects an inclination angle of the display device,
wherein the sensitivity adjuster adjusts the sensitivity of the microphone, according to the inclination angle detected by the inclination angle detector.

6. The electronic apparatus according to claim 5,
wherein the sensitivity adjuster adjusts the sensitivity of the microphone, according to an absolute value of a difference between a predetermined initial angle and the inclination angle.

7. The electronic apparatus according to claim 6,
wherein the sensitivity adjuster raises the sensitivity of the microphone, as the absolute value becomes larger.

8. The electronic apparatus according to claim 1, further comprising a display device,
wherein the control device further acts as a display controller that switches a display of the display device from a normal mode to a universal mode that provides higher visibility than the normal mode, and
the sensitivity adjuster increases a change rate of the sensitivity of the microphone when the display device is set to the universal mode, compared with the change rate in the normal mode.

9. The electronic apparatus according to claim 1,
wherein the controller starts receiving a voice operation by the user, when the gesture recognizer recognizes the predetermined gesture.

10. An image forming apparatus comprising:
the electronic apparatus according to claim 1; and
an image forming device that forms an image on a recording medium.
